(19) United States
(12) Patent Application Publication
(10) Pub. No.: US 2024/0144483 A1
(43) Pub. Date: May 2, 2024

(54) METHOD AND SYSTEM FOR RECOGNIZING OBJECTS, WHICH ARE REPRESENTED IN AN IMAGE BY MEANS OF A POINT CLOUD

(71) Applicant: Gestigon GmbH, Luebeck (DE)

(72) Inventors: Niklas Hermes, Luebeck (DE); Cornelius Reinfeldt, Luebeck (DE)

(73) Assignee: Gestigon GmbH, Luebeck (DE)

(21) Appl. No.: 18/272,224

(22) PCT Filed: Dec. 21, 2021
(86) PCT No.: PCT/EP2021/086957

§ 371 Date: Jul. 13, 2023

(30) Foreign Application Priority Data
Jan. 13, 2021 (DE) 10 2021 100 512.4

(51) Int. Cl. G06T 7/10; G06T 5/20; G06V 40/20

(52) U.S. Cl. CPC G06T 7/10; G06T 5/20; G06V 40/20; G06V 2201/07

(57) ABSTRACT

A method for recognizing one or more objects represented in an image by an M-dimensional point cloud, composed of n points, includes: determining, for each of a number m>0, of specific one-dimensional variables, an associated value of the variable for each of the points on the basis of the position or properties of the point; determining, for each of the variables, a frequency distribution with respect to the respective values of said variable; approximating each of the frequency distributions by a linear combination of a finite number of one-dimensional probability density functions associated with the variable; segmenting the image such that each product of in probability density functions is uniquely assigned a segment of the image; assigning each point of the point cloud to the segment; and identifying at least one of the segments to which at least a predefined minimum number of points was assigned.

The present invention relates to a method and a system for recognizing one or more objects which are represented in an image or in corresponding image data using a point cloud.

In many different technical applications, the task arises of analyzing image data, that is to say data representing an image or a sequence of images, such as a video, to determine whether and, if so, which objects are imaged in the image(s). The recognition of movements or changes in such objects on the basis of such images or image data is also regularly of interest.

In addition to the known methods of photography or the recording of “moving images”, such as video recordings, the methods for generating images or image data also include methods of scanning, in particular discrete scanning, of a real scene with one or more associated real objects (e.g., people or things), in which the resulting image data represent a two-dimensional or three-dimensional point cloud. Such scanning can be carried out in particular using image sensors which also scan a scene in the depth dimension. Examples of such image sensors include, in particular, stereo cameras, time-of-flight sensors (TOF sensors), and electro-optical distance sensors (laser rangefinder (LRF) sensors). Alternatively, such point clouds can also be generated by radar, lidar or ultrasonic sensors. Alternatively, such point clouds can also be generated artificially, however, without a real scene necessarily having to be captured by sensors to this end. In particular, such point clouds can be generated artificially, in particular in computer-aided fashion, as part or as a result of simulations, in particular simulations of real scenes.

In some applications, it may be necessary to segment such a point cloud (in the sense of image processing) in order to be able to distinguish or separate different image regions or regions of the point cloud from one another as segments (i.e., image segments), for example to separate an image foreground from an image background.

A simple, known method for such a foreground/background segmentation for an image given by a point cloud consists in evaluating the depth information with regards to the points of a point cloud by means of a thresholding method, in which all points that, according to their depth information, are closer than a certain depth threshold are assigned to the image foreground, while all other points are assigned to the image background.

If a scene represented by the point cloud contains, for example, two different objects, a separation of the two objects in the image or in the point cloud can also be achieved in this way.

However, such a method is stretched to its limits if the objects are close together, especially in such a way that they overlap in each spatial dimension considered and consequently the respective individual point clouds representing the objects merge into one another without clearly recognizable separation and fuse into a common point cloud.

The present invention is based on the object of further improving the recognition of one or more objects represented by a point cloud in an image or in corresponding image data. In particular, it is desirable to achieve improved separability of different objects in the process.

The solution to this object is achieved according to the teaching of the independent claims. Various embodiments and developments of the invention are the subject matter of the dependent claims.

A first aspect of the invention relates to a method, in particular a computer-implemented method, for recognizing one or more objects represented in an image on the basis of an M-dimensional point cloud of a plurality n of points, where M>1, the method comprising: (i) determining, for each of a number m of specific one-dimensional variables, where m>0, a respective assigned value of the variable for each of the points on the basis of its position or characteristics; (ii) determining, for each of the variables, a respective frequency distribution with respect to the values of this variable determined for the different points in each case; (iii) approximating each of the frequency distributions by means of a respective linear combination of a finite number of one-dimensional probability density functions assigned to the underlying variable; (iv) segmenting the image so that in the case m=1 each of the probability density functions and in the case m>1 each product of m probability density functions, where one, in particular exactly one, of the assigned probability density functions per variable is represented in the product in each case, is uniquely assigned a respective segment of the image; (v) respectively assigning each point of the point cloud to that segment whose assigned probability density function in the case m=1 or whose assigned product in the case m>1 has the relatively largest function value or product value among the probability density functions or products at the location which is determined by the values of the m variables assigned to the point; and (vi) identifying at least one segment of those which were each assigned at least a predetermined minimum number of points as a representative of a respective recognized object.

A “point cloud” within the meaning of the invention should be understood to mean a set of points in a vector space (unless restricted to specific dimensions hereinbelow for embodiments) of any given dimension M>1, which in particular may have an organized or else an unorganized spatial structure. A point cloud is described by the points contained therein, which can each be recorded in particular by their positions specified using spatial coordinates. In addition, attributes, for example geometric normals, color values, temperature values, recording times or measurement accuracies or other information, may be recorded with the points.

A “one-dimensional variable” within the meaning of the invention should be understood to mean any selected variable that can be fully determined one-dimensionally, that is to say as a number (with or without a unit), and which characterizes a property of a point in a point cloud. In particular, the property can be a piece of position information, for instance a spatial coordinate, or an attribute of the point, or it can be derived therefrom. In the case of a piece of position information, the variable can correspond in particular to an assignment of the position to a specific location on a directional line (e.g., coordinate axis), without however being restricted thereto. In another example, however, it could also correspond to a distance of the respective point of the point cloud from a specific reference point, so that, for example, points lying concentrically at the same distance from this reference point have the same value for the variable.

Let X be a continuous random variable (a continuous variable representing one of the one-dimensional characteristic variables in the present case). A “one-dimensional probability density function” within the meaning of the invention then should be understood to mean a mathematical function ƒ(x) of the one-dimensional random variable X, for which the following applies:

[symbol]

(a<X≤b)=∫ₐ^{b}ƒ(x)dx, Where a,b∈ [symbol] , a≤b (1)

ƒ(x)≥0 (2)

∫_{-∞}^{+∞}ƒ(x)dx=c, Where c∈ [symbol] , c>0 (3)
[symbol] (a<X≤b) represents here the probability or actual frequency of the occurrence of a value for x from the value interval [a;b] specified by a and b. Specifically for the value of c=1 of the scaling factor c, this definition of ƒ(x) agrees with the usual definition in mathematics of a probability density function for a one-dimensional continuous random variable. Thus, the concept of a “one-dimensional probability density function” within the meaning of the invention is generalized by comparison, since c may also assume values other than 1 in this case.

A “segment” of an image (or a point cloud) within the meaning of the invention should be understood to be a content-connected region of an image (or a point cloud) which is defined by combining adjacent image points (or points in a point cloud) according to a specific homogeneity criterion. In this case, the homogeneity criterion can relate in particular to a position or coordinate or an attribute of the points, without being restricted thereto. The connection of the region can thus be understood spatially in some cases in particular, while in other cases it may relate in particular to points of the same or similar attributes within the meaning of the homogeneity criterion.

The terms “comprises,” “contains,” “includes,” “has,” “possesses,” “having” or any other variant thereof as may be used herein are intended to cover non-exclusive inclusion. By way of example, a method or a device that comprises or has a list of elements is thus not necessarily limited to those elements, but may include other elements that are not expressly listed or that are inherent in such a method or such a device.

Furthermore, unless expressly stated otherwise, “or” refers to an inclusive or and not to an exclusive “or”. For example, a condition A or B is satisfied by one of the following conditions: A is true (or present) and B is false (or absent), A is false (or absent) and B is true (or present), and both A and B are true (or present).

The terms “a” or “an” as used herein are defined as “one or more”. The terms “another” and “a further” and any other variant thereof should be understood in the sense of “at least one other”.

The term “plurality” as used here should be understood in the sense of “two or more”.

The terms “configured” or “designed” to fulfil a particular function (and respective variations thereof) are understood to mean for the purposes of the invention that the corresponding device is already present in a configuration or setting in which it can perform the function or it is at least adjustable—i.e., configurable—such that it can perform the function after appropriate adjustment. Here, the configuration can be applied, for example, by an appropriate setting of parameters of a process sequence or of switches or similar for activating or deactivating functionalities or settings. In particular, the device may comprise multiple predetermined configurations or operating modes, so that the configuration can be carried out by means of a selection of one of these configurations or operating modes.

The aforementioned method according to the first aspect is therefore based in particular on describing the point cloud using one or more selected, respectively one-dimensional variables that characterize each point in the point cloud on the basis of its position or properties in each case, and in each case approximating (within the sense of the approximation or adjustment calculation) a frequency distribution of the values of the respective variable, based on the above, by means of one-dimensional probability density functions. On the basis of this approximation, in particular the respective function values of the various probability density functions for the values of the respective variable associated with a respective point under consideration, this point can then be unambiguously assigned to a segment of the image or the point cloud. In many cases, this is possible even if the point cloud portions of different objects or of an object and the image background are close to one another. This can be used in particular to separate the image representations of a plurality of objects represented by a point cloud from one another. In particular, this can increase the accuracy of the separation or reduce the error rate. Particularly high accuracies or low error rates can be achieved in the case m>1, since different variables that are independent of one another interact in this case in order to supply even more precise separation criteria for assigning the points to a respective image segment and thus possibly to an associated object. In many cases, it is thus also possible to separate those image representations of objects well from one another which, if only one variable were used, could not be separated or could only be separated with a higher error rate with regard to the point assignment.

Preferred embodiments of the method will be described below, each of which, unless expressly excluded or technically impossible, may be combined as desired with one another and with the further described other aspects of the invention.

In some embodiments for the case m=1, the points in the point cloud are assigned to a respective segment (segmentation criterion) in such a way that each point to be assigned is assigned to a segment of the image on the basis of the result of a comparison of the value of the one-dimensional variable for this point with at least one threshold value. In this case, at least one of the threshold values is defined as a function of a value of the variable at which there is one of the intersection points of at least two of these probability density functions, such that the threshold value corresponds to the value of the variable for this intersection point.

This procedure can also be illustrated in particular by using the threshold value in the M-dimensional space, in which the point cloud is defined, to define a separation line for the case of M=2, a separation plane in the case of M=3, and a separation hyperplane in the case of M>3, which separates points to be assigned to different segments from one another. If there are more than two segments and hence two or more different threshold values, then there are accordingly a plurality of such separation lines or (hyper)planes.

The aforementioned segmentation criterion can thus be defined in a simple manner and be applied efficiently without great computational outlay, in order to assign the individual points to a segment in each case. The definition of the threshold value(s) as a function of the point(s) of intersection of the probability density functions is particularly advantageous here even with regard to the goal of an assignment that is as reliable as possible (with few or no errors). This is because if the probability density functions for the linear combination are determined by the approximation in such a way that they each readily approximate the respective frequency distribution of the variable for a specific object, then, according to the aforementioned relationship (1), their integral over a specific value interval, in which the value for the variable associated with a specific point is located, can be associated with a respective probability that the point belongs to the object approximated by the respective probability density function. Thus, if as a result of the comparison with the threshold value a point is assigned to a particular segment on account of its value for the variable, then this means that said point has a higher probability of belonging to the object associated with this segment than belonging to the other object whose associated segment is separated from the assigned segment by means of the threshold value.

For each of the points of the point cloud, at least one of the m variables specifies a position, projected in a selected fixed spatial direction, of this point in this spatial direction in some embodiments. In this way, in particular, a separation of different objects or of object and background is made possible on the basis of the spatial position of the points (in the spatial direction). By way of example, this can be used to obtain, on the basis of the depth information given by the point positions, a segmentation of the image or the point cloud in a two-dimensional or three-dimensional point cloud (M∈{2;3}) with depth dimension z, in particular also within the meaning of a foreground/background segmentation. In particular, the spatial direction may correspond to the direction of a coordinate axis of a coordinate system used to define the positions of the points in the M-dimensional space.

In some embodiments, the fixed spatial direction is selected so as to run orthogonal to a first principal component that emerges from a principal component analysis applied to the point cloud. This is advantageous in particular for the recognition of objects that should be separated from the background or other objects with regard to one spatial direction which does not coincide with the direction of the first principal component, preferably even is perpendicular or at least substantially perpendicular thereto. Since the first principal component from a principal component analysis represents the dominant component for objects which are not spherically symmetric, it is consequently particularly easily possible thus to separate those objects whose dominant component runs at least largely at an angle to the fixed spatial direction under consideration. For example, if the selected fixed spatial direction corresponds to the depth direction (e.g., “z”-direction) of a depth image, then an arm which is imaged at an angle to the depth direction in the image and whose principal component corresponding to the longitudinal direction of the arm consequently also runs at an angle (e.g., in the x- or y-direction orthogonal to the z-direction) to the selected fixed spatial direction can be recognized or separated particularly well.

Specifically, in some embodiments for which M∈{2;3} applies, the fixed spatial direction can be selected so that it corresponds to the second principal component arising from the principal component analysis in the case M=2 and to the third principal component arising from the principal component analysis in the case M=3. The least dominant of the principal components is consequently selected as the fixed spatial direction, with the result that objects whose more dominant first or second principal components are at an angle, in particular orthogonal, to the fixed spatial direction can thus be recognized or separated particularly well.

In some embodiments, the method further includes: filtering the image so that post filtering it only still contains those points of the point cloud which were assigned to one of the segments respectively identified as a representative of a respective recognized object. In this way, it is possible to implement, in particular, a filter function which has the effect that only the object or the objects of interest is/are recognized or identified, while where applicable other objects or the image background are at least largely ignored (possibly except for those points that were mistakenly assigned to the remaining object or the objects of interest).

Specifically, the filtering of the image in some of these embodiments may be effected so that post filtering it only still contains those points of the point cloud which were assigned to exactly one specific selected segment of the segments that was identified as a representative of an assigned recognized object. A result can thus be achieved in which at most or in particular only exactly one single object is identified.

In some embodiments, in which, for m=1, the variable for each of the points of the point cloud specifies a position, projected in a selected fixed spatial direction, of this point in this spatial direction, the segment selected from the set of segments identified as a representative of a respective recognized object in each case is the segment whose assigned points, in accordance with their positions projected on the selected fixed spatial direction, when viewed in this spatial direction as direction of view, and when considered on average, are closer than the points assigned to any other of the identified segments. This can be advantageously used in particular for the purpose of foreground/background segmentation if only one foremost object (or the foremost object) should be recognized as the foreground.

In some embodiments, m>1 applies and at least one of the m variables indicates a temperature value or a color value for each of the points in the point cloud. Another of the m variables can relate to the position of the respective point in particular. Thus, a particularly reliable, that is to say selective, segmentation can be achieved in particular if the object or the objects to be identified typically have a surface temperature that deviates from their ambient temperature, as is usually the case in particular for living objects, in particular people or animals.

In some embodiments, output data are generated (and preferably output, in particular via an interface) and these represent the result of the implemented assignment of the points to segments or the identification of at least one recognized object in one or more of the following ways: (i) for at least one of the objects, the output data represent an image representation of this object on the basis of one or more of the points, in particular all of the points, of the point cloud which were assigned to the segment belonging to this object; (ii) the output data represent a piece of information that indicates how many different objects were recognized in the image by means of the segment assignment of the points; (iii) the output data represent a piece of information that indicates the respective segment or object to which the points were assigned in each case; (iv) the output data represent a piece of information that, for at least a subset of the points, specifies the respective function value of one or more of the probability density functions at the location determined by the values of the m variables assigned to the point. In the case of option (i), the image representation can be determined in particular by a specific point from the set of points assigned to the segment or as a specific point, in particular a calculated point, in dependence on these points, for example as the center point of the distribution of the points in the set. Instead, the image representation may in particular also be defined as a spatial region or body spanned by the points of the set.

In some embodiments, for at least one of the m variables (in particular for all m variables), the associated (respective) probability density functions each have a curve where the function value, as a function of the value of the variable, increases up to a maximum and then falls again, the maximum being the only maximum that occurs in the curve of the probability density function. Such a function curve, which can be in particular bell-shaped (symmetrical or also asymmetrical), is particularly well suited to the method and in particular to the approximation of frequency distributions for the point clouds generated by scanning objects, particularly if the object or the objects each have a convex shape.

In particular, in some of these embodiments, at least one of the respective probability density functions (in particular each of the probability density functions) for at least one of the m variables can be a Gaussian function. The Gaussian function or Gaussian functions can, in particular, be normalized or be normalizable by means of a parameter (e.g., such that c=1 applies in formula (3) hereinabove). In addition to the aforementioned good suitability for approximating frequency distributions for the point clouds generated by scanning convex objects, the choice of Gaussian functions is also advantageous in that a plurality of known, efficient and robust approximation methods are available to this end.

In some embodiments, at least one of the frequency distributions is subjected to a respective smoothing process and the approximation with regard to this at least one frequency distribution is implemented with regard to the corresponding frequency distribution smoothed by means of the smoothing process. In this way, the quality of the approximation and consequently the quality and reliability of the recognition or separation, based thereon, of objects represented by the point cloud can be further increased.

In some embodiments, a gesture recognition process is carried out on the basis of the respective points of one or more of the segments identified as representatives of a respective object, in order to recognize a person's gesture imaged in the image by means of the point cloud. This can be implemented in particular in the context of an automotive application, in particular in the context of a gesture recognition with regard to gestures performed by an occupant of a vehicle for the purpose of controlling a functionality of the vehicle.

A second aspect of the invention relates to a data processing system having at least one processor configured to carry out the method according to the first aspect of the invention.

In particular, the system can be a computer or a controller for another or higher-level system, for instance for a vehicle or for a production machine or production line.

A third aspect of the invention relates to a computer program having instructions which, when executed on a system according to the second aspect, cause the latter to carry out the method according to the first aspect.

The computer program can, in particular, be stored in a non-volatile data carrier. This is preferably a data carrier in the form of an optical data carrier or a flash memory module. This may be advantageous if the computer program as such is to be handled independently of a processor platform on which the one or more programs are to be run. In another implementation, the computer program can be present as a file on a data processing unit, in particular on a server, and can be downloadable via a data link, for example the Internet or a dedicated data link such as a proprietary or local network. In addition, the computer program can have a multiplicity of individual interacting program modules.

The system according to the second aspect can correspondingly have a program memory in which the computer program is stored. Alternatively, the system can also be configured to access, via a communication link, a computer program which is available externally, for example on one or more servers or other data processing units, in particular in order to exchange therewith data which are used while the method or computer program is running, or constitute outputs of the computer program.

The features and advantages which are explained with respect to the first aspect of the invention apply correspondingly also to the further aspects of the invention.

Further advantages, features and application possibilities of the present invention can be found in the following detailed description in conjunction with the figures.

In the drawings:

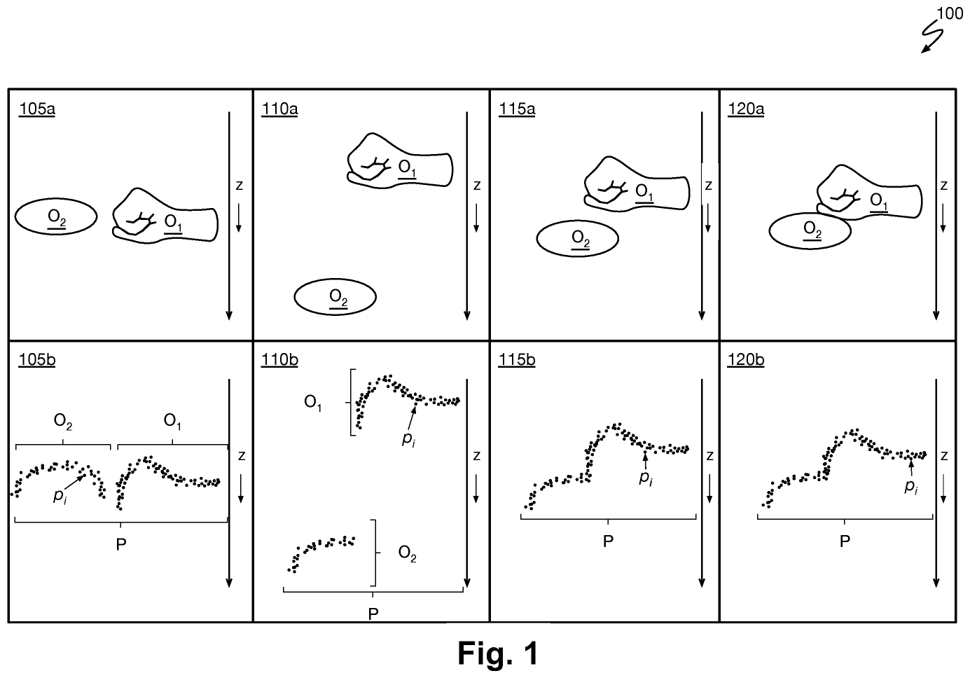

FIG. 1 schematically shows different exemplary scenes, each with an object arrangement of two objects to be separated from one another, and in each case to this end a sectional image of a corresponding point cloud captured by sensors by scanning the scene;

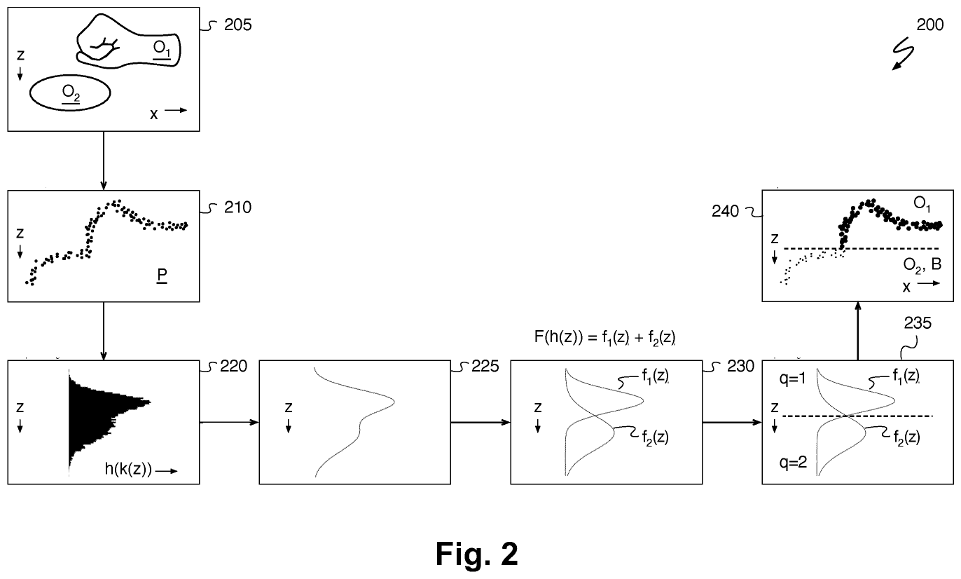

FIG. 2 shows a diagram for illustrating an exemplary embodiment of the method according to the invention for the case m=1;

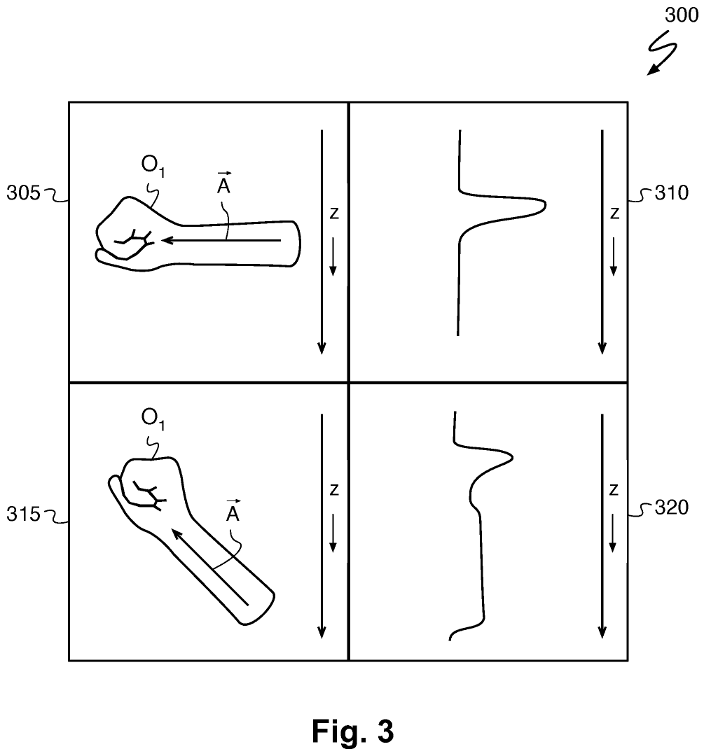

FIG. 3 shows an illustration for illustrating the dependence of the approximation on the choice of a one-dimensional variable; and

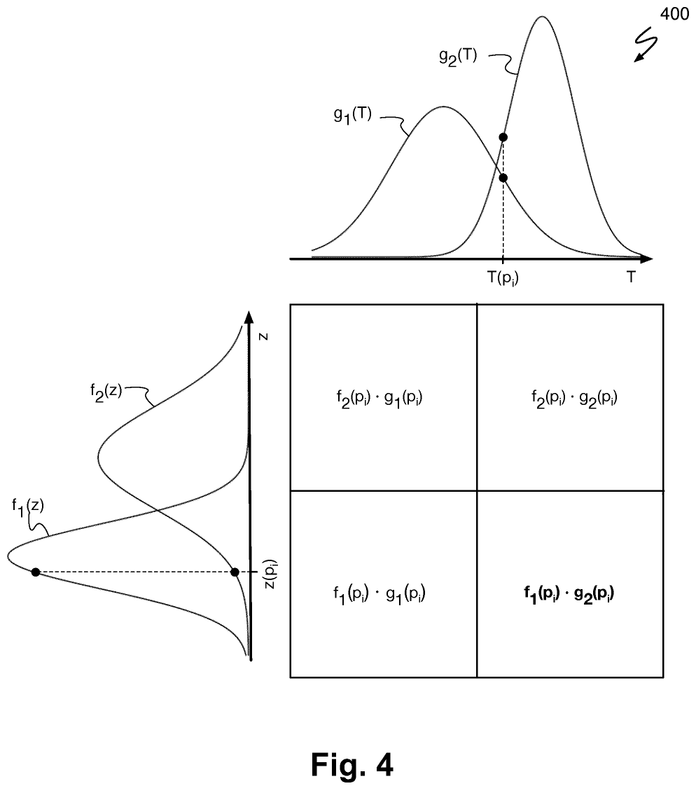

FIG. 4 shows a diagram for illustrating the assignment of points to in each case a specific segment in an exemplary embodiment of the method according to the invention for the case m=2, where, for each point, a local temperature value of the object recorded as an attribute for the respective point is used in additional at the location of the point as the basis of the assignment, in addition to the depth coordinate.

In the figures, the same reference signs are used throughout for the same or corresponding elements of the invention.

To illustrate an exemplary problem addressed by the invention, FIG. 1 depicts an overview 100 of various exemplary scenes 105a, 110a, 115a and 120a and, along with these, a respective corresponding sectional view 105b, 110b, 115b and 120b, respectively, through a point cloud P generated by scanning the respective scene by means of a depth image sensor, in particular a TOF camera (time-of-flight sensor). The depth direction, to which the captured depth image relates and in which a distance is measured from the sensor to the respective object by the depth image sensor, is selected here as the “z”-direction by way of example. Thus, the TOF camera can be thought of as mounted above the scene so that the viewing direction is directed vertically downward in the z-direction. One point pᵢ in the point cloud is given by its (x,y,z)-coordinates, where (x,y) is a (horizontal) plane at right angles to the sensor's line of sight, and z is the depth value, that is to say the distance from the point to the sensor.

Each of the scenes shows a first object O₁, which is formed by a human hand of a person, and any other further object O₂, which can be, for example, another part of the person's body or a body belonging to an interior of a vehicle.

In the case of scene 105a, the two objects O₁ and O₂ are located laterally next to one another in a direction perpendicular to the z-direction (e.g., x-direction), with a gap lying between them in this direction. On account of this gap, the point cloud portions corresponding to the two objects O₁ and O₂, as illustrated in the sectional view 105b, can easily be separated from one another and can each be assigned to a separate image segment or. Here, this assignment is essentially error-free, at any rate if the gap is larger than the average point spacing within the point cloud P.

In the case of scene 110a, the two objects O₁ and O₂ are offset from one another in the z-direction, with a gap lying between them in the z-direction. On account of this gap, the point cloud portions corresponding to the two objects O₁ and O₂, as illustrated in the sectional view 110b, can also easily be separated from one another here due to their respectively clearly different depth values (z-coordinates) and can each be assigned to their own image segment and hence object O₁ or O₂. This assignment is also essentially error-free, at any rate if the gap is larger than the average point distance within the point cloud P.

By contrast, in the case of scene 115a, the two objects O₁ and O₂ are offset separated from one another only by a very small gap in the z-direction and they overlap in the direction perpendicular to the z-direction. In this case, the corresponding point cloud P in view 115b no longer allows the point cloud P to be divided into point cloud portions or segments corresponding in each case to the two objects O₁ and O₂ in a similarly simple and error-free manner on the basis of a recognized gap, like in scenes 105a and 110a, since the average point spacing within the point cloud P is similar in size to the gap.

The starting point for an object separation is even more difficult in the case of scene 120a, in which the two objects O₁ and O₂ overlap or are in contact with one another both in the z-direction and in a direction perpendicular thereto, with the result that there is no longer a gap which is imageable by the point cloud P and hence an object separation or segmentation using simple means, as explained for scenes 105a and 105b, becomes unreliable or fails completely.

In the exemplary embodiment 200 of a method according to the invention illustrated in FIG. 2, a plurality of objects, here by way of example two objects O₁ and O₂, containing scene 205 are scanned by image sensors, in particular by means of a depth image sensor, for instance a TOF camera, in order to generate an image representation of the scene in the form of a point cloud P, as shown in view 210. The image data output by the depth image sensor can, in particular for each of the points pᵢ of the point cloud P, represent the point's respective coordinate in the depth direction, selected here as the z-direction, and optionally further coordinates or additionally measured properties of the objects. In this context, the following explanations of the method 200 focus on the z-coordinate, which initially should be taken into account as the only one-dimensional variable used within the scope of the method 200, and so the case m=1 is initially considered here. The case m>1 will be addressed hereinbelow with reference to FIG. 4.

Starting from the point cloud P, a frequency distribution h(k) is determined with respect to the z-coordinates of the points occurred in the point cloud, where k=k(z) represents discrete values of z, as will be explained in detail hereinbelow. In view 220, the resulting frequency distribution h(k) is illustrated using a histogram representing the latter.

For example, for the frequent case M=3, this can be expressed mathematically in generalized fashion by way of example as follows for any depth values (one-dimensional variables): Let P={p₁, . . . , pₙ} be a three-dimensional point cloud and d∈ [symbol] ³ be a given unit vector in a specific direction, referred to herein as the “depth direction”. By way of example, let this be the z-direction in the present example. Further, let dᵢ:= [symbol] pᵢ, d [symbol] ∈ [symbol] be the directed depth (depth value) of the point pᵢ, where [symbol] pᵢ, d [symbol] denotes the dot product of the two vectors pᵢ and d. The set of depth values {d₁, . . . , dₙ} (equivalent to the set of z-coordinates of the points {pᵢ, . . . , pₙ} in the present example) serves as the basis for the further steps for object separation or segmentation.

A frequency distribution with respect to the depth values {d₁, . . . , dₙ} can now be determined as follows, specifically as a histogram: Such a (depth) histogram has a certain granularity γ>0. For example, γ=1 cm could be selected. To obtain a good compromise between result quality of the segmentation or object identification on the one hand and the efficiency of the method, in particular in terms of computational outlay, on the other hand, the choice of γ should be based on the requirements of the respective application. Now, let kᵢ:=└dᵢ/γ┘∈ [symbol] for each depth value dᵢ, where └·┘ symbolizes rounding down. For j∈ [symbol] , let nⱼ now be the number of those i∈{1, . . . , n}, for which j=kᵢ is applicable. Then the mapping h_{P}: [symbol] [symbol] [symbol] :j [symbol] nⱼ defines such a histogram for the frequency distribution.

This can be described vividly as follows: the value range of the possible depth values is subdivided into a sequence of sections of length γ and each point pᵢ of the point cloud P, at least each point to be assigned to a segment, is assigned to one of the sections according to its depth value dᵢ. Then, for each value j∈ [symbol] , the histogram indicates the number of points whose depth value approximately (i.e., rounded down in the present example) corresponds to j·γ. The finitely large granularity requires the aforementioned discretization, since all values of dᵢ are assigned the same value kᵢ for k within the same section.

Now referring again to the specific example of FIG. 2, the frequency distribution h(k) is approximated within the further course of the method 200, preferably after smoothing (view 225) was applied to said frequency distribution, by a finite linear combination of probability density functions which, in the present case, were each selected as normalized Gaussian functions. This results in a corresponding approximation function F(h(z))=f₁(z)+f₂(z) formed using the Gaussian functions, in the present case formed using two different Gaussian functions f₁(k) and f₂(k), as illustrated in view 230. Hence, F(h(z)) is an approximation of the (smoothed) frequency distribution from view 225.

As usual, a normalized Gaussian function should in this case be understood to be a function ƒ: [symbol] [symbol] [symbol] which is representable by the following formula, where the mean value μ of the distribution, the standard deviation σ and the normalization factor c are each a parameter of the function f (the notation “ƒ” and “f” are used synonymously herein; the same applies accordingly to various notations used for other symbols) and, with regard to the method 200, z is chosen as the independent variable in this case:

$$f ( z ) = c \cdot \frac{1}{σ \sqrt{2 π}} \cdot {e}^{- \frac{1}{2} {( \frac{z - μ}{σ} )}^{2}} \qquad ( 4 )$$

The approximation problem therefore consists in finding the number N of different Gaussian functions fᵢ and the respective parameter set {μᵢ, σᵢ, cᵢ} with i=1, . . . , N for each function thereof, so that the (smoothed) frequency distribution h(k) for each value of k (i.e., the corresponding discrete z-value) is approximated by the sum of these Gaussian functions:

h(k)≈Σ₁^{N}ƒ_{q}(k) (5)

The choice of Gaussian functions for the approximation is advantageous in various respects. In particular, it has been shown that such functions can supply a very good approximation for frequency distributions as they occur when scanning convex bodies, in particular also many body parts of the human body, for instance arms and legs or the head, using a depth image sensor. If each punctiform distance measurement during the scan is considered to be an independent random variable, then the good suitability of Gaussian functions for the aforementioned approximation can also be justified mathematically, in particular, on the basis of the central limit value theorem.

Furthermore, various efficient methods for a function approximation using Gaussian curves are available. This includes, for example, an approximation method described in A. Goshtasby, W. D. O'Neill, “Curve Fitting by a Sum of Gaussians”, CVGIP: Graphical Models and Image Processing, Vol. 56. Mp 4, July, 1994, pp. 281-288. Further examples of applicable approximation methods can be found in particular on the Internet at: https://www.researchgate.net/publication/252062037_A_Simple_Algorithm_for_Fitting_a_Gaussian_Function_DSP_Tips_and_Tricks/link/544732410cf22b3c14e0c0c8/download or at https://stats.stackexchange.com/questions/92748/multi-peak-gaussian-fit-in-r.

If the Gaussian functions f_{q}(z) are determined by means of the approximation, then each of these Gaussian functions can be used to define a segment of the image or the point cloud P represented thereby. Then, for each point pᵢ∈P, the probability of that point pᵢ belonging to a respective particular segment can be interpreted such that this probability is proportional to f_{q}(dᵢ). In the present example, the associated function value f₁(dᵢ) for each point pᵢ∈P indicates the probability of this point pᵢ belonging to a first segment of the image and correspondingly the corresponding function value f₂(dᵢ) for each point pᵢ∈P indicates the probability of this point pᵢ belonging to a second segment of the image different from the first segment.

A separation of the two segments can thus be implemented in particular, as illustrated, by each point pᵢ being assigned in each case uniquely to that segment q whose function value f_{q}(dᵢ) for that point is the highest among the various function values for that point. This assignment rule is illustrated in view 235, where the dashed separation line runs exactly through the intersection of the two functions f₁ and f₂, and all points above this dividing line are assigned to the first segment (q=1) represented by f₁ and all points below this dividing line are assigned to the second segment (q=2) represented by f₂. Should a point pᵢ actually be lying on the dividing line (within the accuracy of the representation of dᵢ), it is possible in that case to provide a predetermined assignment to a selected one of the segments in order to avoid ambiguities. However, this case will usually not occur or rather will occur very rarely in the case of a sufficiently high representation accuracy of dᵢ.

On the basis of this segment assignment, it is now possible, as illustrated in view 240, to implement an identification of one object or, in this case, two objects O₁ and O₂ by assigning in each case all points of a respective segment to exactly one of these objects O₁ and O₂. The respective segment is thus determined as a representative of the respectively associated object.

Alternatively, however, it is also possible to filter the point cloud on the basis of the segmentation prior to the object assignment, with the result that (except in the limiting case where all points were assigned to the same object) only a real subset of the segments remains post filtering and serves as a basis for the object assignment. In the present example, the segment for q=2, for example, which corresponds to the larger depth values z can be filtered out in this way. Thus, for q=1, the first segment can be determined as a representative of an identified object O₁ (in this example a single identified object) in the image foreground (nearest segment in z-direction), while the second segment for q=2 is not interpreted as an identified object, but rather not interpreted at all or for instance interpreted as image background B.

As illustrated in FIG. 3 on the basis of an exemplary comparison 300 of two different scenarios, the choice of the one-dimensional variable, especially in the case where it corresponds to a position in a specific direction (in this case the z-direction by way of example), can influence the resulting frequency distribution, thus influence the functions determined therefrom by approximation and finally also influence the quality of the segment assignment and object identification.

In a first scenario, illustrated in view 305, the z-direction is chosen to run orthogonally to a main direction of extent, represented by the direction vector Z\vec{A}, of the hand of a person to be identified as object O₁ in the context of the method. Within the scope of the approximation, for example using Gaussian functions again in this case, the situation shown in view 310 arises, whereby the frequency distribution can even be well approximated using a single Gaussian function, which in turn leads to a simple and very reliable and precise identification of the object O₁.

By contrast, in the second scenario illustrated in view 315, the z-direction is chosen so that it no longer runs orthogonally, but at a smaller angle with respect to the main direction of extent, represented by the direction vector \vec{A}, of the shown hand of a person to be identified as object O₁ in the context of the method. In the context of the approximation using Gaussian functions, the situation shown in view 320 arises, whereby the frequency distribution can only be well approximated using a linear combination of a plurality of Gaussian functions, which in turn leads to a more difficult and possibly less reliable or less precise identification of the object O₁.

The choice of the one-dimensional variable is therefore clearly preferable in the case of the first scenario. Accordingly, the method 200 can in particular provide for the one-dimensional direction to be selected in such a way on the basis of the result of a principal component analysis that a fixed spatial direction is selected for the one-dimensional variable such that it runs orthogonally to a first principal component resulting from a principal component analysis applied to the point cloud. In particular, in the present exemplary case, the second principal component emerging from the principal component analysis can be selected to this end in the case of M=2 and the third principal component emerging from the principal component analysis can be selected to this end in the case of M=3 (cf. direction vector \vec{A} in view 305). In this way, the least dominant principal component (along the z-direction in this case) is selected, which usually optimizes the probability of the most dominant principal component running at least predominantly perpendicular thereto and hence to the scanning direction (the z-direction in this case), thus resulting in a scenario that tends to approximate the first scenario with an optimized segment assignment and object assignment.

FIG. 4 relates to an extension of the method, in particular also of the method 200, to the case m>1. The diagram 400 serves for the exemplary illustration of the assignment of points to a respective specific segment in an exemplary embodiment of the method according to the invention for the case m=2.

Consider again the exemplary problem of discriminating a hand O₁ from a background B. This problem can be addressed as follows. As yet, only the depth information of the pixel has been exploited in the method 200, but even this advanced approach can have limitations: For example, if, in the context of recording an image in a motor vehicle, the hand (of the driver) is held next to the gear stick at a certain point in time, to be precise at the same depth level from the point of view of the image sensor so that the same or very similar depth values z arise for the points of a point cloud resulting from scanning the scene, then the segmentation of the image or the point cloud purely on the basis of the depth values into a segment for the hand and a segment for the background B (or the gear lever as the second object O₂) may possibly fail.

In general, a situation may arise for certain scenes where the points that can be distinguished by the method for m=1 (i.e., they belong to different Gaussian curves) belong to different objects, but there is no guarantee that those points that are not discriminated in this way belong to the same object. In other words, any function, especially a Gaussian function, possibly represents only an object category (i.e., a set of a plurality of objects that are not further discriminated by the chosen feature) and not necessarily exactly one single object in such a case.

One approach to improving the method in terms of its selectivity comprises the extension by taking account of at least one additional one-dimensional variable so that m>1 applies. In particular, as illustrated in FIG. 4, a local temperature value T recorded for the respective point can additionally be used as a second variable and thus as an additional basis for the assignment at any point pᵢ, in addition to the depth coordinate z.

An assumption is now made, by way of example, that the hand has a higher (surface) temperature than the background and a classification of the points p, according to their respective local temperature value Tᵢ accordingly supplies a second frequency distribution h′(k′(T)), or h′(T) for short, which is related to the temperature as an independent variable, which frequency distribution in turn, according to the method 200, can be approximated by a linear function of distribution density functions gᵢ, albeit related to the temperature rather than the z-coordinate.

A purely temperature-based segmentation and object identification based thereon (corresponding to view 240) can now be carried out either in a corresponding application of the segmentation according to view 235 from FIG. 2. This still corresponds to the m=1 case, albeit with a temperature-based segmentation rather than a depth-value-based (z-coordinate-based) segmentation.

However, as illustrated in FIG. 4, it is even more effective to use both variables z and T in combination as the basis for the segmentation. Here, the variable z allows the point cloud to be subdivided into the categories of near object and distant object or image background. In parallel, the thermal variable (temperature) T can subdivide the points into the categories of “warm objects” and “cold objects”. In the present example, a distinction can thus be made between at least four categories (or corresponding segments): (i) a warm and simultaneously near object, (ii) a warm and simultaneously distant object, (iii) a cold and simultaneously near object, and (iv) a cold and simultaneously distant object. The image background B can optionally also be viewed as a distant object in each case.

Mathematically, such a generalization can be represented in particular as follows:

Again, let P={p₁, . . . , pₙ} be a point cloud generated by the sensory scanning of the scene, with each point pᵢ being assigned, in addition to a depth value z, a measured local temperature value T at the location of the measured position of the respective point pᵢ in addition.

As described above, an approximation according to equation (5) is made for the depth z of the points, which is initially considered as a single variable, in order to determine a linear combination of functions f_{q}(z) which approximates the depth value distribution of the points. Each of the functions f_{q}(z) again represents a depth segment in this case.

In the same way, an approximation is made according to equation (5) for the temperature (local temperature values T) of the points, which is also initially considered as a single variable, in order to determine a linear combination of functions, in particular Gaussian functions, gᵣ(T) which approximates the temperature value distribution of the points. Here, each of the functions gᵣ(T) represents a temperature segment.

Then, the value of the product f_{q}(z(pᵢ))·gᵣ(T(pᵢ)), or in abbreviated notation ƒ_{q}(pᵢ)·gᵣ(pᵢ), can be interpreted as proportional to the probability of the point pᵢ belonging to the combined segment (q, r) formed as the intersection of the depth segment with respect to q and the temperature segment with respect to r, where q and r each are subscripts for consecutively numbering the functions ƒ_{q} and gᵣ, respectively. The value of this product is now used to assign the respective point pᵢ to a particular one of the combined segments such that the product for this combined segment is largest in relative terms, corresponding to a selection of the most likely assignment.

Specifically, in the example of FIG. 4, for the product for the selected point pᵢ, the combination ƒ₁(pᵢ)·g₂(pᵢ) is largest among all combinations, with the result that the specific point pᵢ is assigned to the combined segment (1; 2), which corresponds to the closest and at the same time warmest object in this case. The points of this combined segment can thereupon be identified as points of an object to be recognized, in this case the hand O₁.

The method according to the invention, in its various variants, can be used for a wide variety of applications. Such applications include, in particular, the separation of image representations of different body parts of a person, of different people or of one or more people on the one hand and one or more other objects on the other hand, in each case from one another or from a background. In particular, the method can be used to separate one or more body parts of a person in an image captured by sensors, in order thereupon, on the basis of the result of such a separation or segmentation and a subsequent identification of the body parts as objects, to carry out a gesture recognition with regard to any of the possible gestures performed by the person.

While at least one exemplary embodiment has been described above, it has to be noted that there are a large number of variations in this respect. It is also to be noted here that the described exemplary embodiments constitute only non-limiting examples and they are not intended to limit the scope, the applicability or the configuration of the devices and methods described here as a result. Instead, the above description will provide a person skilled in the art with an indication for the implementation of at least one exemplary embodiment, wherein it is understood that various changes in the means of functioning and the arrangement of the elements described in an exemplary embodiment can be made without departing here from the subject matter which is respectively defined in the appended claims and its legal equivalents.

### LIST OF REFERENCE SIGNS

100 Overview of various exemplary scenes
105a-120a Various scenes
105b-120b Point clouds for the various scenes 105a-120a
200 Exemplary method for recognizing objects
205-240 Views of intermediate stages of the method 200
300 Comparison of two different scenarios
305 First scenario
310 Approximation function for the first scenario
315 Second scenario
320 Approximation function for the second scenario
400 Diagram for illustrating an exemplary assignment of points in the case of m=2
\vec{A} Direction vector of the first principal component of an object
B Background
f_{q} Set of probability density functions, in particular Gaussian functions, for approximating a frequency distribution of depth values
gᵣ Set of probability density functions, in particular Gaussian functions, for approximating a frequency distribution of depth values
h(z) Frequency distribution
P Point cloud
pᵢ Single point of the point cloud
O₁; O₂ Objects
T Temperature
z Depth

1. A method for recognizing one or more objects represented in an image on the basis of an M-dimensional point cloud of a plurality n of points, where M>1, the method comprising:
determining, for each of a number m of specific one-dimensional variables, where m>0, a respective assigned value of the variable for each of the points on the basis of its position or characteristics;
determining, for each of the variables, a respective frequency distribution in relation to the values of this variable determined for the different points in each case;
approximating each of the frequency distributions by a respective linear combination of a finite number of one-dimensional probability density functions assigned to the underlying variable;
segmenting the image so that:
in the case m=1 each of the probability density functions and in the case m>1 each product of m probability density functions, where one of the assigned probability density functions per variable is represented in the product in each case, is uniquely assigned a respective segment of the image,
respectively assigning each point of the point cloud to that segment whose assigned probability density function in the case of m=1 or whose assigned product in the case of m>1 has the relatively largest function value or product value among the probability density functions or products at the location which is determined by the values of the m variables assigned to the point, and
identifying at least one segment of those which were each assigned at least a predetermined minimum number of points as a representative of a respective recognized object.

2. The method as claimed in claim 1, wherein, for each of the points of the point cloud, the at least one of the m variables specifies a position, projected in a selected fixed spatial direction, of this point in this spatial direction.

3. The method as claimed in claim 2, wherein the fixed spatial direction is selected so as to run orthogonally to a first principal component that emerges from a principal component analysis applied to the point cloud.

4. The method as claimed in claim 3, wherein M∈{2; 3} and the fixed spatial direction is selected so that it corresponds to the second principal component arising from the principal component analysis in the case M=2 and to the third principal component arising from the principal component analysis in the case M=3.

5. The method as claimed in claim 2, further comprising:
filtering the image so that post filtering it only still contains those points of the point cloud which were assigned to one of the segments respectively identified as a representative of a respective recognized object.

6. The method as claimed in claim 5, wherein the image is filtered so that post filtering it only still contains those points of the point cloud which were assigned to exactly one specific selected segment of those segments identified as a representative of an assigned recognized object.

7. The method as claimed in claim 6, wherein m=1 and the segment selected from the set of segments identified in each case as a representative of a respective recognized object is the segment whose assigned points, in accordance with their positions projected on the selected fixed spatial direction, when viewed in this spatial direction as direction of view, and when considered on average, are closer than the points assigned to any other of the identified segments.

8. The method as claimed in claim 1, wherein m>1 and at least one of the m variables for each of the points of the point cloud indicates a temperature value or a color value.

9. The method as claimed in claim 1, wherein output data are generated and these represent the result of the implemented assignment of the points to segments or the identification of at least one recognized object in one or more of the following ways:
for at least one of the objects, the output data represent an image representation of this object on the basis of one or more of the points of the point cloud which were assigned to the segment belonging to this object;
the output data represent a piece of information that indicates how many different objects were recognized in the image by means of the segment assignment of the points;
the output data represent a piece of information that indicates the respective segment or object to which the points were assigned in each case;
the output data represent a piece of information that, for at least a subset of the points [[(p,)]], specifies the respective function value of one or more of the probability density functions at the location determined by the values of the m variables assigned to the point.

10. The method as claimed in claim 1, wherein, for at least one of the m variables, the associated probability density functions each have a curve where the function value, as a function of the value of the variable, increases up to a maximum and then falls again, the maximum being the only maximum that occurs in the curve of the probability density function.

11. The method as claimed in claim 10, wherein at least one of the respective probability density functions for at least one of the m variables is a Gaussian function.

12. The method as claimed in claim 1, wherein at least one of the frequency distributions is subjected to a respective smoothing process and the approximation with regard to this at least one frequency distribution is implemented with regard to the corresponding frequency distribution smoothed by the smoothing process.

13. The method as claimed in claim 1, wherein a gesture recognition process is carried out on the basis of the respective points of one or more of the segments identified as a representative of a respective object, in order to recognize a person's gesture imaged in the image by means of the point cloud.

14. A data processing system having at least one processor configured to carry out the method as claimed in claim 1.

15. A computer program having instructions which, when executed on a system as claimed in claim 14, cause the latter to carry out the method as claimed in claim 1.
